(19) United States
(12) Patent Application Publication
(10) Pub. No.: US 2026/0131279 A1
(43) Pub. Date: May 14, 2026

(54) ABSORPTION COLUMN ASSEMBLY WITH ABSORPTION COLUMN MODULES

(71) Applicant: INDUSTRIAL CLIMATE SOLUTIONS INC., Calgary (CA)

(72) Inventors: Jahan Ahmadi, Calgary (CA); William Hargrove, Easton, MD (US); Augusta Pedacchia, Sezze (IT)

(21) Appl. No.: 18/944,567

(22) Filed: Nov. 12, 2024

(51) Int. Cl. B01D 53/18; B01D 53/14

(52) U.S. Cl. CPC B01D 53/18; B01D 53/1425; B01D 2258/0283

(57) ABSTRACT

An absorption column assembly includes an absorption column extending between an upstream end and a downstream end. The absorption column includes a plurality of absorption column modules extends between the upstream and downstream ends of the absorption column. A system includes a stripping structure and an absorption column assembly including an absorption column extending between an upstream end and a downstream end. The absorption column includes a plurality of absorption column modules extending between the upstream and downstream ends of the absorption column. The absorption column assembly is configured to receive lean solvent and flue gas or atmospheric air. Each of the plurality of absorption column modules is configured to cause the lean solvent to absorb a component of the gas or the atmospheric air into the lean solvent to form rich solvent and lean gas.

### BACKGROUND

Various manufacturing and chemical systems, e.g., oil refineries, produce flue gases including components such as carbon dioxide. While the flue gases from these systems may be exhausted into the atmosphere, it is desirable to remove one or more of the components, e.g., carbon dioxide, from the flue gases prior to release into the atmosphere. In the case of carbon dioxide, such removal is referred to as carbon capture. Additionally, it may be desirable to remove a component, e.g., carbon dioxide, from atmospheric air. In the case of carbon dioxide, such removal is referred to as direct air capture (DAC). Improvements to systems for capturing a component from flue gases and/or atmospheric air may be desirable.

### SUMMARY

An embodiment of an absorption column assembly including an absorption column extending between an upstream end and a downstream end, wherein the absorption column comprises a plurality of absorption column modules extending between the upstream and downstream ends of the absorption column.

An embodiment of a system including a stripping structure, and an absorption column assembly comprising an absorption column extending between an upstream end and a downstream end, the absorption column comprising a plurality of absorption column modules extending between the upstream and downstream ends of the absorption column, wherein the absorption column assembly is configured to receive lean solvent and flue gas or atmospheric air, wherein each of the plurality of absorption column modules is configured to cause the lean solvent to absorb a component of the gas or the atmospheric air into the lean solvent to form rich solvent and lean gas, wherein the system is configured to provide the rich solvent from the absorption column assembly to the stripping structure, wherein the stripping structure is configured to remove the component from the rich solvent to form lean solvent and the component in concentrated form, and wherein the system is configured to provide the lean solvent from the stripping structure to the absorption column.

An embodiment of an absorption column assembly including an absorption column extending between an upstream end and a downstream end, wherein the absorption column comprises an absorption column module extending between the upstream and downstream ends of the absorption column, and wherein the absorption column comprises an absorption column casing encasing the absorption column module extending between the upstream and downstream ends of the absorption column.

### BRIEF DESCRIPTION OF THE DRAWINGS

The following descriptions should not be considered limiting in any way. With reference to the accompanying drawings, like elements are numbered alike:

FIG. 1 shows a simplified schematic diagram of a system according to one or more embodiments;

FIG. 2 shows an absorption column assembly according to one or more embodiments;

FIG. 3 shows an absorption column module according to one or more embodiments;

FIG. 4A shows a cross-sectional view of the absorption column module of FIG. 3 taken at 4A-4A;

FIG. 4B shows a perspective view of a corrugated screen according to one or more embodiments;

FIG. 5 shows a cross-sectional view of the absorption column assembly of FIG. 2 taken at 5-5;

FIG. 6 shows a cross-sectional view of an absorption column assembly according to one or more embodiments;

FIG. 7 shows a cross-sectional view of an upstream collector structure according to one or more embodiments;

FIG. 8 shows a cross-sectional view of a downstream collector structure according to one or more embodiments; and

FIG. 9 shows a simplified schematic diagram of an absorption column assembly with a cooling system according to one or more embodiments.

### DETAILED DESCRIPTION

A detailed description of one or more embodiments of the disclosed apparatus and method are presented herein by way of exemplification and not limitation with reference to the Figures.

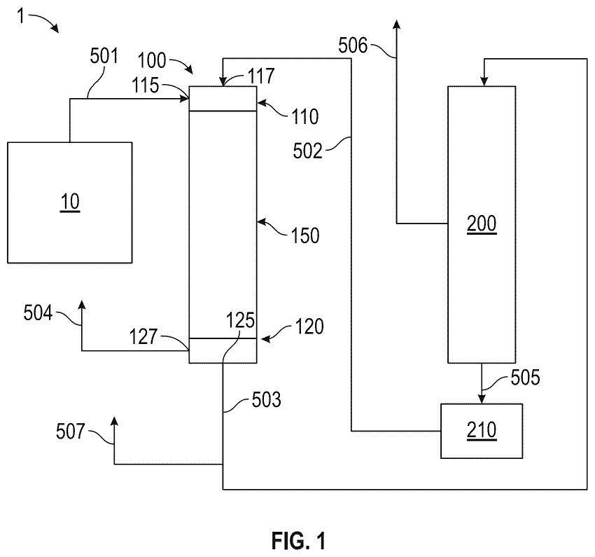

A simplified schematic diagram of a system 1 according to one or more embodiments is shown in FIG. 1. The system 1 may be, for example, a carbon capture system, although the present disclosure is not limited thereto. The system 1 may include a flue gas source 10. The flue gas source 10 may be, for example, a manufacturing or chemical system that produces a flue gas which may contain, for example, carbon dioxide. The flue gas source 10 may be an oil refinery. While FIG. 1 shows the system 1 processing gas from a flue gas source 10, the system 1 may instead process atmospheric air. Thus, while the present disclosure discusses processing of flue gases, it should be understood atmospheric air may replace the flue gas in the system 1.

The system 1 further includes an absorption column assembly 100. The absorption column assembly 100 may include an upstream collector structure 110, an absorption column 150 downstream of the upstream collector structure 110, and a downstream collector structure 120 downstream of the absorption column 150.

The upstream collector structure 110 may include a flue gas inlet 115 and a solvent inlet 117, and the downstream collector structure 120 may include a rich solvent outlet 125.

A flue gas line 501 may extend from the flue gas source 10 to the flue gas inlet 115 of the upstream collector structure 110 to feed the flue gas into the absorption column assembly 100. A lean solvent line 502 may extend from a lean solvent source 210 to the solvent inlet 117 that feeds lean solvent from lean solvent source 210 to the absorption column 100. The lean solvent source 210 may be, for example, a lean solvent tank. According to one or more embodiments, the lean solvent may be heated prior to entering the upstream collector structure 110. For example, the lean solvent source 210 may include a heater.

The upstream collector structure 110 is configured to combine the flue gas entering from the flue gas inlet 115 and the lean solvent entering from the solvent inlet 117 and the combined flue gas and lean solvent is fed into the absorption column 150. The absorption column 150 absorbs a component of the flue gas into the lean solvent to form a mixture of lean gas with the component removed therefrom and rich solvent with the component absorbed therein. The mixture of the lean gas and the rich solvent is fed into the downstream collector structure 120.

The rich solvent line 503 may extend from the rich solvent outlet 125 of the downstream collector structure 120 to a stripping structure 200. A first lean gas line 504 may extend from a lean gas outlet 127 of the downstream collector structure 120 to remove the lean gas therefrom. Additionally or alternatively, a second lean gas line 507 may extend from the rich solvent line 503 to remove the lean gas therefrom.

The stripping structure 200 may receive the rich solvent from the absorption column assembly 100 via the rich solvent line 503 and separate the component from the rich solvent to form lean solvent and the component in concentrated form. A tank line 505 may extend from the stripping structure 200 to the solvent tank 210 such that the lean solvent from the stripping structure 200 enters to the solvent tank 210. As explained above, the lean solvent line 502 feeds the lean solvent from the solvent tank 210 into the lean solvent inlet 117 of the upstream collector structure 117. Alternatively or additionally, the lean solvent may be fed directly from the stripping structure 200 into the upstream collector structure 110. A concentrated component line 506 may extend from the stripping structure 200 to remove the component in concentrated form therefrom.

While a stripping structure 200 is shown in FIG. 1, the system 1 may employ a regeneration structure and/or a desorption structure instead or in addition to the stripping structure 200. The lean solvent may be liquid solvent. As used herein, “lean solvent” may refer to solvent with little or no component, e.g., carbon dioxide, of the flue gas therein, and “rich solvent” may refer to a solvent with a significant amount of the component, e.g., carbon dioxide, of the flue gas absorbed therein. As used herein, “lean gas” may refer to the flue gas after the component, e.g., carbon dioxide, has been removed therefrom via the absorption column 100 such that it has little or none of the component, e.g., carbon dioxide therein. The solvent may be an amine, amino acid salts, carbonate systems, aqueous ammonia, immiscible liquids, ionic liquids, or another liquid solvent known in the art that is effective for capturing the component.

The stripping structure 200 may be any stripping structure for separating a component, e.g., carbon dioxide, from rich solvent. As a non-limiting example, the stripping structure 200 may include a stripper column, a reboiler, a condenser, and a reflux drum, a solvent tank, and/or a cooler. The stripper column may include packing material, trays, sprays, etc. As noted above, a regeneration structure and/or a desorption structure instead or in addition to the stripping structure 200. In the case of the desorption structure, a desorption column/equipment may be employed for pressure-swing operation such as a flash column.

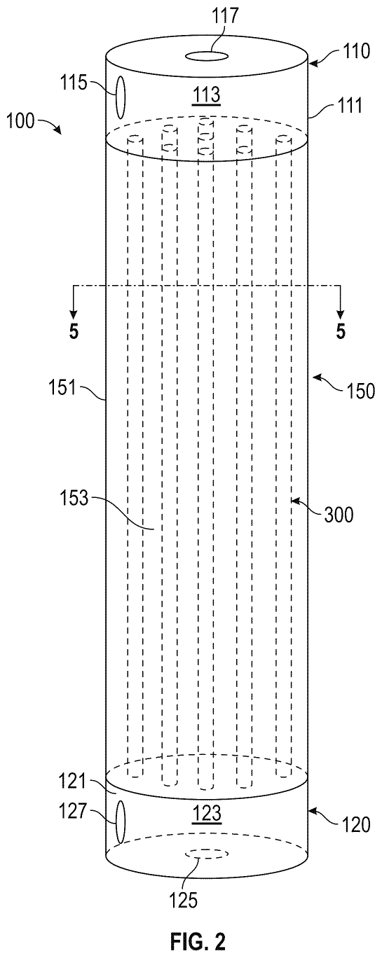

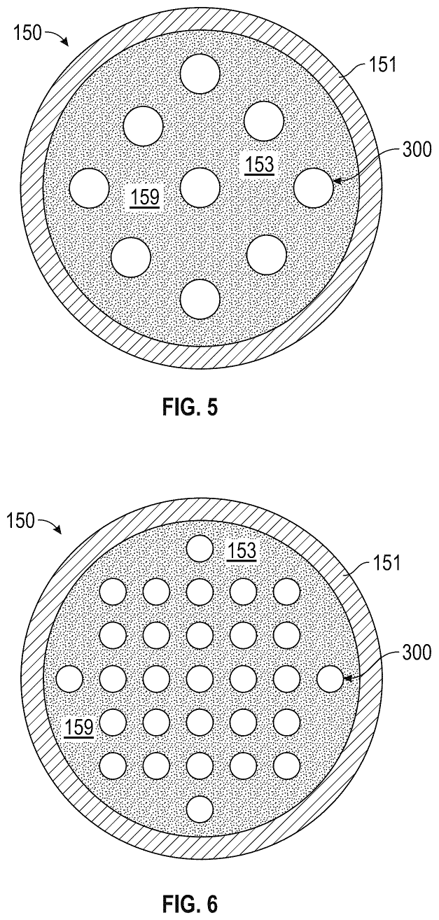

FIG. 2 shows an absorption column assembly 100 according to one or more embodiments, and FIG. 5 shows a cross-sectional view of the absorption column assembly of FIG. 2 taken at 5-5. As shown in FIGS. 2 and 5, the absorption column 150 may include an outer shell 151 that defines a column space 153 therein. The outer shell 151 is an example of an absorption column casing. A plurality of absorption column modules 300 may be disposed within the outer shell 151, each of the absorption column modules 300 extending from the upstream collector structure 110 to the downstream collector structure 120. According to one or more embodiments, the absorption column modules 300 extend parallel to each other. The absorption column modules 300 may be spaced apart. While nine of the absorption column modules 300 are shown in FIGS. 2 and 5, the present disclosure is not limited thereto. That is, the absorption column assembly 100 may include any plurality of the absorption column modules 300. As a further non-limiting example, FIG. 6 shows twenty-nine absorption column modules 300 in the absorption column 150. While embodiments are shown in which the absorption column modules 300 are disposed within the outer shell 151, according to one or more embodiments, the outer shell 151 may be omitted such that the absorption column 150 includes a plurality of absorption column modules 150 that are not encased. Each of the absorption column modules 300 may be sized identically. Alternatively, the absorption column modules 300 may be sized differently.

As a non-limiting example, the plurality of absorption column modules 300 may include two or more absorption column modules 300. As a non-limiting example, the plurality of absorption column modules 300 may include three or more absorption column modules 300. As a non-limiting example, the plurality of absorption column modules 300 may include four or more absorption column modules 300.

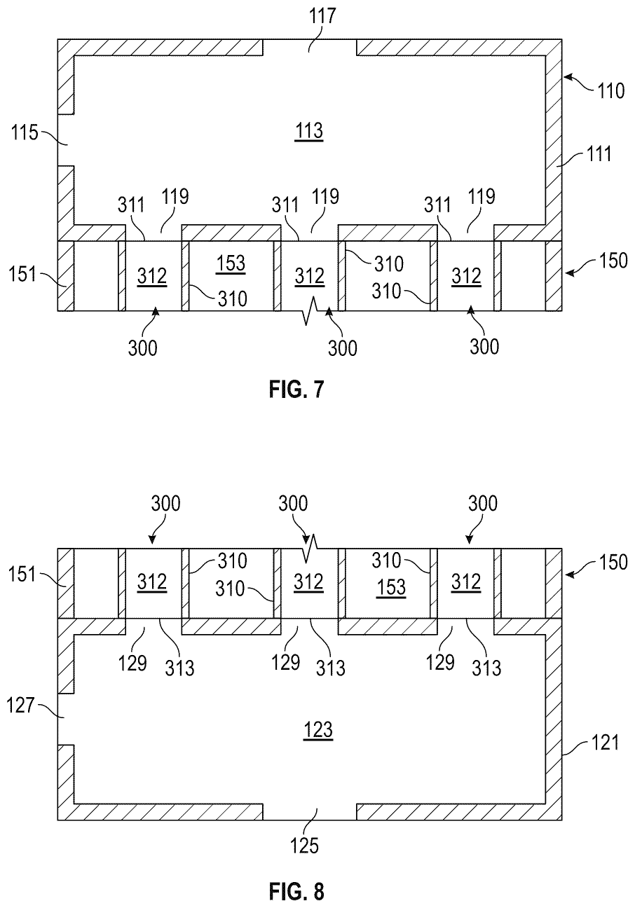

FIG. 7 shows a cross-sectional view of the upstream collector structure 110 according to one or more embodiments. As shown in FIGS. 2 and 7, the upstream collector structure 110 may include an upstream collector casing 111 that defines an upstream collector space 113 therein. The upstream collector casing 111 may further define a flue gas inlet 115, a lean solvent inlet 117, and a plurality of upstream collector outlets 119. As shown in FIG. 1, the flue gas inlet 115 may be fluidly coupled to a flue gas line 501, and the lean solvent inlet 117 may be fluidly coupled to the lean solvent line 502. The upstream collector outlets 119 may be fluidly coupled to module inlets 311 of absorption column modules 300. The upstream collector structure 110 receives flue gas through the flue gas inlet 115 and receives lean solvent through the lean solvent inlet 117, and the flue gas and the lean solvent are combined within the upstream collector space 113. The upstream collector structure 110 may be configured to pre-mix the flue gas and the lean solvent within the upstream collector space 113. The combination of the flue gas and the lean solvent is then fed from the upstream collector structure 110 into the absorption column 150. Specifically, the combination of the flue gas and the lean solvent is fed through the upstream collector outlets 119 into the modules inlets 311 of the absorption column modules 300.

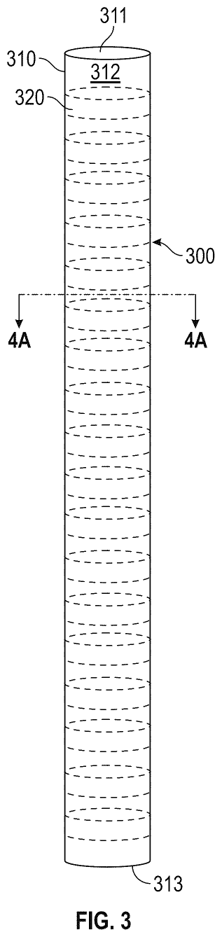

FIG. 3 shows an absorption column module 300 according to one or more embodiments. The absorption column module 300 may include a module casing 310 that defines the module inlet 311 at a first longitudinal end, a module outlet 313 at a second longitudinal end, and a module space 312 therebetween. As a non-limiting example, the module casing 310 may be structured as a pipe. As non-limiting examples, the module casing 310 may be metallic, ceramic, polymeric, and/or composite. The module casing 310 may be of any size and shape. As a non-limiting example, the module casing 310 may have a diameter between 4 and 24 inches. A plurality of corrugated screen packing modules 320 may be disposed within the module space 312. While FIG. 3 shows eighteen corrugated screen packing modules 320, the present disclosure is not limited thereto. That is, the absorption column module 300 may include any plurality of the corrugated screen packing modules 320. The combination of the flue gas and the lean solvent pass through each of the corrugated screen packing modules 320, resulting in the component from the flue gas being absorbed into the lean solvent, forming a mixture of flue gas with the component removed therefrom and rich solvent with the component absorbed therein.

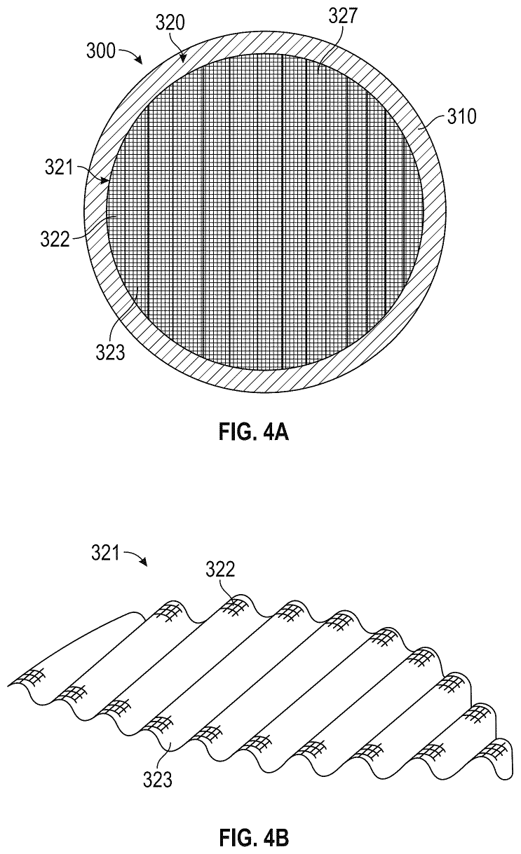

A non-limiting example of a corrugated screen packing module 320 is shown in FIG. 4A. The corrugated screen packing module 320 may be disposed within the module casing 310 and may include a corrugated screen 321. The corrugated screen 321 may include ridges 322 and valleys 323 in an alternating arrangement, a non-limiting example of which is shown in FIG. 4B. According to one or more embodiments, apertures 327 formed in the corrugated screen 321 sized and arranged to maximize the solvent pulsing effect while minimizing the packing material. The corrugated screen packing modules 320 may induce the absorption column module 300 to operate under a froth condition in two-phase flow with millions of bubbles and droplets being formed in the absorption column module 300. The bubbles may be created as bands of froth collapse and are regenerated. The pulse flow may occur due to a hydrodynamic multi-phase phenomenon depending on the flow rates and the design of the corrugated screen packing modules 320. The flue gas may pass through multiple zones of froth along the corrugated screen packing modules 320, and the component of the flue gas may get absorbed into the lean solvent.

According to one or more embodiments, the absorption column module 300 may be a regenerative froth contactor (RFC) equipped with the corrugated screen packing modules 320 having no moving parts and may operate in a downward co-flow configuration. The corrugated screen packing modules 320 may be formed of convoluted screens that may increase a solvent pulsing effect, and may decrease metal packing material, by inducing the absorption column module 300 to operate under a transient froth condition in two phase flow. The pulse flow may be set up as a hydrodynamic multi-phase phenomenon, corresponding to a specific region in a flow map within the absorption column module 300. Mass transfer may take place in pulses of froth formed by gas and liquid. As bands of froth propagate down the absorption column module 300, the absorber enables a high contact surface area and excellent mixing, with millions of bubbles and droplets created as bands of froth collapse and are regenerated. The component of the flue gas may thus be transferred from the flue gas into the liquid phase in the froth in a whole volume of the absorption column module 300, while the corrugated screen packing modules 320 may govern the froth. The applicable flow map may depend on characteristics of fluids and selected geometry of the corrugated screen packing modules 320. For some gas/liquid systems, a geometry of the corrugated screen packing modules 320 may be selected to enforce a preferred pulse area on the flow map and a coarser or thinner froth, through effects of the corrugated screen packing modules 320 on the hydrodynamic regime.

The absorption column modules 300 may enable accommodation of high gas flow rates and liquid/gas ratios, without excessive back pressure or flooding within the absorption column modules 300. The absorption column modules 300 may also be used in processes with precipitating solvents or high levels of entrained solids, leading to three-phase contactors. The absorption column 300 may experience minimal or no fouling or additional pressure drop penalty, even under high particulate loads and high viscosity.

As the flue gas and the lean solvent flow co-currently through the corrugated screen packing modules 320, an exothermic reaction may occur when the component, e.g., carbon dioxide, is absorbed from the flue gas into the lean solvent. The exothermic reaction may generate significant heat. Because of the co-current flow of the flue gas and the lean solvent, the heat flows downstream with the co-current flow. As the lean solvent heats up, the capacity thereof to absorb the component decreases.

As shown in FIGS. 5 and 6, according to one or more embodiments, a thermal fluid 159 may be disposed within the column space 153. The thermal fluid 159 may be in contact with outer surface of the module casing 310 of each of the absorption column modules 300 to remove heat therefrom. By removing heat from the absorption column modules 300, the capacity of the lean solvent to absorb the component may be maintained. As non-limiting examples, the thermal fluid may be water, oil, chemical fluid, or biological fluid. The thermal fluid may be liquid, gas, or a liquid and gas mixture. The thermal fluid may also include solid particles dispersed therein to aid in heat transfer. The thermal fluid may be a mixture of different types of fluid.

FIG. 8 shows a cross-sectional view of the downstream collector structure 120 according to one or more embodiments. As shown in FIGS. 2 and 8, the downstream collector structure 120 may include a downstream collector casing 121 that defines a downstream collector space 123 therein. The downstream collector casing 121 may further define a plurality of downstream collector inlets 129, a rich solvent outlet 125, and a lean gas outlet 127. As shown in FIG. 1, the rich solvent outlet 125 may be fluidly coupled to a rich solvent line 503, and the lean gas outlet 127 may be fluidly coupled to the first lean gas line 504. The downstream collector inlets 129 may be fluidly coupled to module outlets 313 of absorption column modules 300. The downstream collector structure 120 receives the mixture of the lean flue gas and the rich solvent from the absorption column modules 300 within the downstream collector space 123 via the downstream collector inlets 129. The rich solvent within the downstream collector space 123 may be removed via the rich solvent outlet 125, and the lean flue gas within the downstream collector space 123 may be removed via the lean gas outlet 127. Alternatively, the lean gas outlet 127 may be omitted such that the mixture of the lean flue gas and the rich solvent may be removed from the downstream collector structure 120 together via the rich solvent outlet 125 and separated outside of the absorption column assembly 100, e.g., from the rich solvent line 503 via the second lean gas line 507.

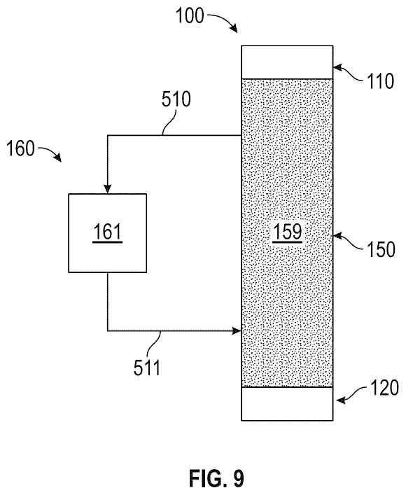

As shown in FIG. 9, the absorption column assembly 100 may further include a cooling system 160 fluidly coupled to the absorption column 150. The cooling system 160 may include a cooling structure 161. The cooling structure 161 may include, for example, a heat exchanger. For example, a first thermal fluid line 510 may extend from the absorption column 150 to the cooling structure 161, and a second thermal fluid line 511 may extend from the cooling structure 161 to the absorption column 150. The first thermal fluid line 510 may receive thermal fluid 159 heated by the absorption column modules 300 and transport the thermal fluid 159 to the cooling structure 161 which cools the thermal fluid 159. The thermal fluid 159 that is cooled by the cooling structure 161 may be fed back into the absorption column 150 via the second thermal fluid line 511.

While a cooling system 160 is described above, for some applications, it may be beneficial to heat the absorption column modules 300. In such a case, a heating system may be employed instead of the cooling system 160. The heating system would be similar to the cooling system 160 except that the cooling structure 161 would be replaced by a heating structure.

According to one or more embodiments, arranging a plurality of absorption column modules 300 in the absorption column assembly 100 allows for a common size of components to be used for different absorption column assemblies 100. For example, for a larger absorption column assembly 100, a number of the absorption column modules 300 may be increased. Furthermore, each of the absorption column modules 300 may operate independently of the others such that, even if one of the absorption column modules 300 operates at a lower efficiency, the other absorption column modules 300 may still operate efficiently.

According to one or more embodiments, thermal fluid 159 may surround the absorption column modules 300. The thermal fluid 159 may cool the absorption column modules 300 to maintain absorption capacity of the solvent. The thermal fluid 159 may alternatively be used to heat the absorption column modules 300 in applications where it would be advantageous to do so. The thermal fluid 159 may also dampen vibration of the absorption column modules 300.

According to one or more embodiments, the upstream collector structure 110 may allow for pre-mixing of the lean solvent with the flue gas or the atmospheric gas to improve efficiency of the absorption column modules 300.

Although an example of carbon dioxide is set forth with respect to a component to be removed from the flue gas and/or environmental gas, the system 1 may also be applicable to H₂S, SO₂, O₂ COS, etc. As non-limiting examples, the system 1 may be applicable to H₂S removal with amine solvent, CO₂ removal with NaOH, SO₂ removal with NaOH, SO₂ removal with H₂O₂, SO₂ removal with HCl, O₂ removal with aqueous Sodium sulfite, and COS removal with amine solvents, among others. The absorption column assembly 100 may be applicable to any application that involves absorption of a component into a solvent.

### Set Forth Below Are Some Embodiments of the Foregoing Disclosure:

Embodiment 1: An absorption column assembly including an absorption column extending between an upstream end and a downstream end, wherein the absorption column comprises a plurality of absorption column modules extending between the upstream and downstream ends of the absorption column.
Embodiment 2: The absorption column assembly as in any prior embodiment, wherein each of the absorption column modules comprises a plurality of corrugated screen packing modules.
Embodiment 3: The absorption column assembly as in any prior embodiment, wherein the absorption column comprises an absorption column casing encasing the plurality of absorption column modules extending between the upstream and downstream ends of the absorption column.
Embodiment 4: The absorption column assembly as in any prior embodiment, wherein the absorption column casing defines a column space in which the plurality of absorption column modules are disposed, thermal fluid being disposed within the column space outside of the absorption column modules.
Embodiment 5: The absorption column assembly as in any prior embodiment, wherein the plurality of absorption column modules are arranged parallel to each other.
Embodiment 6: The absorption column assembly as in any prior embodiment, further including an upstream collector structure disposed at the upstream end of the absorption column.
Embodiment 7: The absorption column assembly as in any prior embodiment, wherein the upstream collector structure comprises a first inlet, a second inlet, and a plurality of outlets fluidly connected to inlets of the plurality of absorption column modules.
Embodiment 8: The absorption column assembly as in any prior embodiment, wherein the upstream collector structure comprises an upstream collector casing that defines an upstream collector space configured to pre-mix fluids entering from the first inlet and the second inlet.
Embodiment 9: The absorption column assembly as in any prior embodiment, wherein the first inlet is configured to be fluidly connected to a flue gas source or atmospheric air and the second inlet is configured to be fluidly connected to a lean solvent source.
Embodiment 10: The absorption column assembly as in any prior embodiment, further comprising a downstream collector structure disposed at the downstream end of the absorption column.
Embodiment 11: The absorption column assembly as in any prior embodiment, wherein the downstream collector structure comprises an outlet and a plurality of inlets fluidly connected to outlets of the plurality of absorption column modules.
Embodiment 12: The absorption column assembly as in any prior embodiment, wherein the outlet is configured to be fluidly connected to a stripping structure.
Embodiment 13: The absorption column assembly as in any prior embodiment, wherein the thermal fluid comprises at least one of water, oil, chemical fluid, biological fluid, or a mixture thereof.
Embodiment 14: The absorption column assembly as in any prior embodiment, wherein solid particles are dispersed in the thermal fluid.
Embodiment 15: The absorption column assembly as in any prior embodiment, wherein the plurality of absorption column modules are spaced apart.
Embodiment 16: The absorption column assembly as in any prior embodiment, wherein the plurality of absorption column modules comprises three or more absorption column modules.
Embodiment 17: The absorption column assembly as in any prior embodiment, further comprising a cooling system fluidly coupled to the column space and configured to cool the thermal fluid.
Embodiment 18: The absorption column assembly as in any prior embodiment, wherein each of the plurality of absorption column modules is configured to receive a gas and lean solvent and configured to absorb a component of the gas into the lean solvent.
Embodiment 19: The absorption column assembly as in any prior embodiment, wherein each of the plurality of absorption column modules is a regenerative froth contactor.
Embodiment 20: A system including a stripping structure, and an absorption column assembly comprising an absorption column extending between an upstream end and a downstream end, the absorption column comprising a plurality of absorption column modules extending between the upstream and downstream ends of the absorption column, wherein the absorption column assembly is configured to receive lean solvent and flue gas or atmospheric air, wherein each of the plurality of absorption column modules is configured to cause the lean solvent to absorb a component of the gas or the atmospheric air into the lean solvent to form rich solvent and lean gas, wherein the system is configured to provide the rich solvent from the absorption column assembly to the stripping structure, wherein the stripping structure is configured to remove the component from the rich solvent to form lean solvent and the component in concentrated form, and wherein the system is configured to provide the lean solvent from the stripping structure to the absorption column.
Embodiment 21: An absorption column assembly including an absorption column extending between an upstream end and a downstream end, wherein the absorption column comprises an absorption column module extending between the upstream and downstream ends of the absorption column, and wherein the absorption column comprises an absorption column casing encasing the absorption column module extending between the upstream and downstream ends of the absorption column.
Embodiment 22: The absorption column assembly as in any prior embodiment, wherein the absorption column casing defines a column space in which the absorption column module is disposed, thermal fluid being disposed within the column space outside of the absorption column modules.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. An absorption column assembly comprising:
an absorption column extending between an upstream end and a downstream end,
wherein the absorption column comprises a plurality of absorption column modules extending between the upstream and downstream ends of the absorption column.

2. The absorption column assembly of claim 1, wherein each of the absorption column modules comprises a plurality of corrugated screen packing modules.

3. The absorption column assembly of claim 1, wherein the absorption column comprises an absorption column casing encasing the plurality of absorption column modules extending between the upstream and downstream ends of the absorption column.

4. The absorption column assembly of claim 3, wherein the absorption column casing defines a column space in which the plurality of absorption column modules are disposed, thermal fluid being disposed within the column space outside of the absorption column modules.

5. The absorption column assembly of claim 1, wherein the plurality of absorption column modules are arranged parallel to each other.

6. The absorption column assembly of claim 1, further comprising an upstream collector structure disposed at the upstream end of the absorption column.

7. The absorption column assembly of claim 6, wherein the upstream collector structure comprises a first inlet, a second inlet, and a plurality of outlets fluidly connected to inlets of the plurality of absorption column modules.

8. The absorption column assembly of claim 7, wherein the upstream collector structure comprises an upstream collector casing that defines an upstream collector space configured to pre-mix fluids entering from the first inlet and the second inlet.

9. The absorption column assembly of claim 7, wherein the first inlet is configured to be fluidly connected to a flue gas source or atmospheric air and the second inlet is configured to be fluidly connected to a lean solvent source.

10. The absorption column assembly of claim 1, further comprising a downstream collector structure disposed at the downstream end of the absorption column.

11. The absorption column assembly of claim 10, wherein the downstream collector structure comprises an outlet and a plurality of inlets fluidly connected to outlets of the plurality of absorption column modules.

12. The absorption column assembly of claim 11, wherein the outlet is configured to be fluidly connected to a stripping structure.

13. The absorption column assembly of claim 4, wherein the thermal fluid comprises at least one of water, oil, chemical fluid, biological fluid, or a mixture thereof.

14. The absorption column assembly of claim 4, wherein solid particles are dispersed in the thermal fluid.

15. The absorption column assembly of claim 1, wherein the plurality of absorption column modules are spaced apart.

16. The absorption column assembly of claim 1, wherein the plurality of absorption column modules comprises three or more absorption column modules.

17. The absorption column assembly of claim 4, further comprising a cooling system fluidly coupled to the column space and configured to cool the thermal fluid.

18. The absorption column assembly of claim 1, wherein each of the plurality of absorption column modules is configured to receive a gas and lean solvent and configured to absorb a component of the gas into the lean solvent.

19. The absorption column assembly of claim 1, wherein each of the plurality of absorption column modules is a regenerative froth contactor.

20. A system comprising:
a stripping structure; and
an absorption column assembly comprising an absorption column extending between an upstream end and a downstream end, the absorption column comprising a plurality of absorption column modules extending between the upstream and downstream ends of the absorption column,
wherein the absorption column assembly is configured to receive lean solvent and flue gas or atmospheric air,
wherein each of the plurality of absorption column modules is configured to cause the lean solvent to absorb a component of the gas or the atmospheric air into the lean solvent to form rich solvent and lean gas,
wherein the system is configured to provide the rich solvent from the absorption column assembly to the stripping structure,
wherein the stripping structure is configured to remove the component from the rich solvent to form lean solvent and the component in concentrated form, and
wherein the system is configured to provide the lean solvent from the stripping structure to the absorption column.

21. An absorption column assembly comprising:
an absorption column extending between an upstream end and a downstream end,
wherein the absorption column comprises an absorption column module extending between the upstream and downstream ends of the absorption column, and
wherein the absorption column comprises an absorption column casing encasing the absorption column module extending between the upstream and downstream ends of the absorption column.

22. The absorption column assembly of claim 21, wherein the absorption column casing defines a column space in which the absorption column module is disposed, thermal fluid being disposed within the column space outside of the absorption column modules.
